(19) United States
(12) Patent Application Publication
(10) Pub. No.: US 2026/0032629 A1
(43) Pub. Date: Jan. 29, 2026

(54) EARLY POSITION INFORMATION ACQUISITION METHOD AND APPARATUS

(71) Applicant: ZTE Corporation, Shenzhen (CN)

(72) Inventors: Ting LU, Shenzhen (CN); Li NIU, Shenzhen (CN)

(21) Appl. No.: 19/349,001

(22) Filed: Oct. 3, 2025

Related U.S. Application Data
(63) Continuation of application No. PCT/CN2023/087117, filed on Apr. 7, 2023.

(51) Int. Cl. H04W 64/00; H04W 52/02; H04W 74/0833; H04W 76/28

(52) U.S. Cl. CPC H04W 64/00; H04W 52/0216; H04W 74/0833; H04W 76/28

(57) ABSTRACT

A wireless communication method includes transmitting, by a wireless device to a network device, an indication indicating that the wireless device is starting a position reacquisition procedure at a first time that is earlier than a second time according to a rule for starting the position reacquisition procedure. One example of the position reacquisition procedure includes acquiring global navigation satellite system information.

### CROSS-REFERENCE TO RELATED APPLICATIONS

This application is a continuation of International Patent Application No. PCT/CN2023/087117, filed on Apr. 7, 2023, the contents of which are incorporated herein by reference in their entirety.

### TECHNICAL FIELD

This patent document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), and non-terrestrial network (NTN) systems.

In one example aspect, a wireless communication method is disclosed. The method includes transmitting, by a wireless device to a network device, an indication indicating that the wireless device is starting a position reacquisition procedure at a first time that is earlier than a second time according to a rule for starting the position reacquisition procedure.

In another example aspect, another wireless communication method is disclosed. The method includes receiving, by a network device from a wireless device, an indication indicating that the wireless device is starting a position reacquisition procedure at a first time that is earlier than a second time according to a rule for starting the position reacquisition procedure; and performing a subsequent operation based on the indication.

In another example aspect, another wireless communication method is disclosed. The method includes transmitting, by a wireless device to a network device, an indication indicating that the wireless device has completed a position reacquisition procedure started at a first time that is earlier than a second time according to a rule for starting the position reacquisition procedure.

In another example aspect, another wireless communication method is disclosed. The method includes receiving, by a network device from a wireless device, an indication indicating that the wireless device has completed a position reacquisition procedure started at a first time that is earlier than a second time according to a rule for starting the position reacquisition procedure; and performing a subsequent operation based on the indication.

In another example aspect, another wireless communication method is disclosed. The method includes transmitting, by a wireless device to a network device, an indication indicating that the wireless device is starting a position reacquisition procedure at a first time due to the wireless device determining that a remaining time of validity of a position fix information is less than a threshold.

In another example aspect, another wireless communication method is disclosed. The method includes receiving, by a network device from a wireless device, an indication indicating that the wireless device is starting a position reacquisition procedure at a first time due to the wireless device determining that a remaining time of validity of a position fix information is less than a threshold; and performing a subsequent operation based on the indication.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the above-described method.

The above and other aspects and their implementations are described in greater detail in the drawings, the descriptions, and the claims.

### BRIEF DESCRIPTION OF THE DRAWINGS

FIG. 1 illustrates an example of an NTN network.

FIG. 2 illustrates example options for position information reacquisition during a connected mode operation.

FIG. 3 illustrates an example of a discontinuous reception (DRX) cycle.

FIG. 4A illustrates examples of early start for position information reacquisition during inactive state of connected DRX (C-DRX) mode.

FIG. 4B illustrates examples of early start for position information reacquisition during inactive state of connected DRX (C-DRX) mode.

FIG. 4C illustrates examples of early start for position information reacquisition during inactive state of connected DRX (C-DRX) mode.

FIG. 5A-5C are flowcharts illustrating example methods performed by wireless devices.

FIG. 6A-6C are flowcharts illustrating example methods performed by network devices.

FIG. 7 is a block diagram example of a wireless communication system.

FIG. 8 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

### 1. Introduction

In terrestrial network deployment, the users and service are so concentrated that the network is mainly located in the city, factory, rural and so on. In the sparsely populated place, the network deployment is expensive, hard or even unavailable. However, with the progress of science and technology, there is a great demand to collect the data and communicate in the remote regions. For example, to collect the meteorological data in the mountain peak or desert.

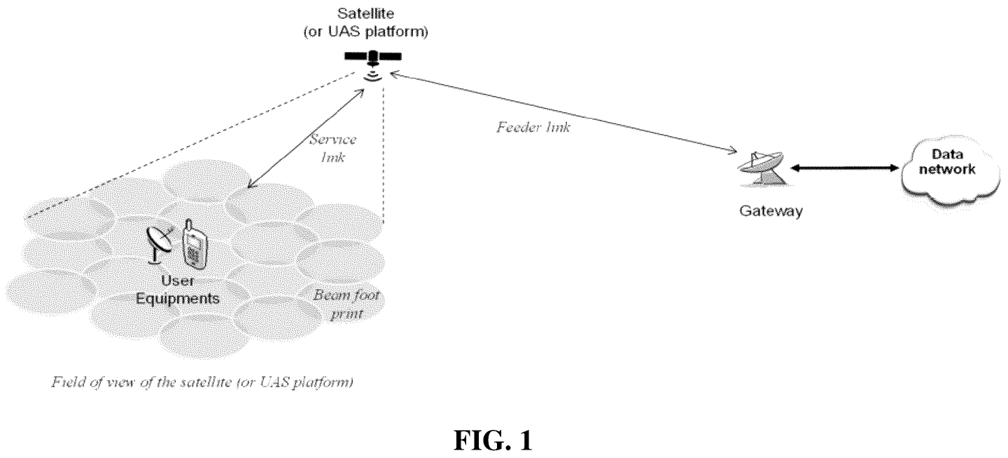

In non-terrestrial deployments, the satellite can provide large coverage even in the remote regions. The non-terrestrial network deployment can be considered to extend the coverage of terrestrial network, and further extend the business of cellular network operators. The typical scenario of a non-terrestrial network providing access to user equipment is depicted in FIG. 1.

As depicted in FIG. 1, one or more wireless devices such as user equipment UE may be within coverage of a satellite or an unmanned aerial system (UAS) platform. Each ellipse on the left side shows a footprint of a geographic region served by a beam.

The NTN Gateway is an earth station or gateway which is located at the surface of Earth and provides sufficient RF power and RF sensitivity for accessing to the satellite (resp. HAPS). NTN Gateway is a transport network layer (TNL) node. The feeder link is the wireless link between NTN Gateway and satellite. The service link is the radio link between satellite and UE. The satellite (or UAS platform) typically generates several beams over a given service area bounded by its field of view. The footprints of the beams are typically of elliptic shape.

The satellite can be placed into Low Earth Orbit (LEO), or Geostationary Earth Orbit (GEO). Geostationary Earth orbit is the circular orbit at 35,786 km above the Earth's equator and following the direction of the Earth's rotation. A GEO satellite in such an orbit has an orbital period equal to the Earth's rotational period and thus appears motionless, at a fixed position in the sky, to ground observers. The typical beam footprint size of GEO is 200-3500 km. Low Earth Orbit is the orbit around the Earth with an altitude between 300 km, and 1500 km. An LEO satellite in such an orbit travel around the earth with the speed of 7.56 km per second. The typical beam footprint size of LEO is 100-1000 km.

Moreover, the IoT (internet of things) connectivity requires the large coverage, thus, the IoT connectivity has a great need for the non-terrestrial network deployment. So, the narrowband IoT (NB-IoT) or eMTC (enhanced machine type communication) over the non-terrestrial network (abbreviated as IoT NTN) is the trend of technology development.

### 2. GNSS Reacquisition When UE in Connected Mode

In the satellite scenario, UE can obtain its own position information by acquiring GNSS. The radio network also broadcasts satellite assistant information, e.g., ephemeris information through the system information, which facilitates UE to trace the position of the satellite and calculate the timing advance information (abbreviated as TA).

After UE obtains its own position and the position of the satellite, it can calculate the distance between itself and the satellite, and combine the timing advance information broadcast by the radio network to calculate the uplink synchronization information required by UE and the radio network to maintain uplink synchronization. However, GNSS position fix information, ephemeris information, and timing advance information are only valid for a certain period of time, and when the validity timer expires, this information will become invalid. That means, the timing advance calculated by UE based on this information will be also invalid. Then the UE needs to reacquire this information (the position information), calculate the timing advance amount and obtain the uplink synchronization again. Here a GNSS validity duration timer and a TA validity duration timer are used to determine whether the GNSS and TA are still valid, respectively.

In 3GPP release 17 (R17) IoT NTN, there is assumption that UE's connection is are generally short as it's mainly for short, sporadic services. Therefore, the UE is only required to acquire/reacquire the GNSS position fix before establishing the connection to avoid interruption during the connection. However, if in rare case, the GNSS position fix still becomes out-of-date while UE is in RRC_CONNECTED, the UE will enter idle mode to reacquire GNSS position fix.

For further enhancements for IoT NTN, reacquisition of the GNSS position fix during the long connections are required. It's expected that, for UE in connected mode, when GNSS position fix becomes invalid, UE could reacquire GNSS and then continue the service transmission. However, for an IoT UE in connected mode, when the UE tries to reacquire GNSS position fix, UE cannot simultaneously receive scheduling data from the radio network. In other word, if the radio network sends service data to the UE when the UE is getting GNSS position fix, the UE will lose the service data. In order to avoid such an issue, the radio network should not schedule the service data to the UE when the UE obtains GNSS position fix, which requires the radio network to be aware of the time when the UE starts to reacquire the GNSS position fix, and also the length of total time required by the UE to reacquire GNSS position fix.

The length of total time required by the UE to reacquire GNSS position fix may be referred to as GNSS position fix time duration, which is mainly determined by the GNSS start mode. For example, for hot start, the GNSS Position Time To First Fix (TTFF) is 1 s or 2 s, for warm start, the TTFF time is several seconds, and for cold start the TTFF time is 30 s. Here is a further assumption that, after the UE successfully acquires GNSS position fix when connecting to the NW, GNSS start mode can keep unchanged for the whole duration of the connection, e.g., always in hot start mode or warm start mode. So GNSS position fix time duration can also be expected to remain unchanged.

In the following section, we will discuss the solution for reducing the interruption time caused by reacquisition of the GNSS position fix during the connected mode.

Generally, UE in connected mode can take one of the following ways to perform GNSS reacquisition the GNSS reacquisition:
Option 1: The radio network can send a trigger at or shortly after UE enters into the RRC connected mode. This trigger can be sent only once and mainly for enabling UE to perform GNSS measurement, but does not mean that the UE needs to start GNSS measurement immediately when it receives the trigger. As time goes by, only when the GNSS validity duration timer expires, UE will start to reacquire the GNSS position fix. This can be seen as a periodical reacquisition of GNSS position fix, e.g., taking the GNSS validity duration as a periodicity.
Option 2: UE performs GNSS reacquisition only upon reception of the explicit trigger from radio network. The trigger from radio network can further explicitly indicate the gap and the start time for GNSS measurement. It is radio network's implementation on how to configure the start position and duration of the measurement gap. For example, the measurement gap should be equal to or larger than the GNSS position fix time duration. And the start time of the measurement can be calculated based on some configured parameters and certain given formula (e.g., after subframe+X+k_{mac}, where k is the subframe where the UE would transmit a HARQ-ACK for the NPDSCH carrying the trigger).

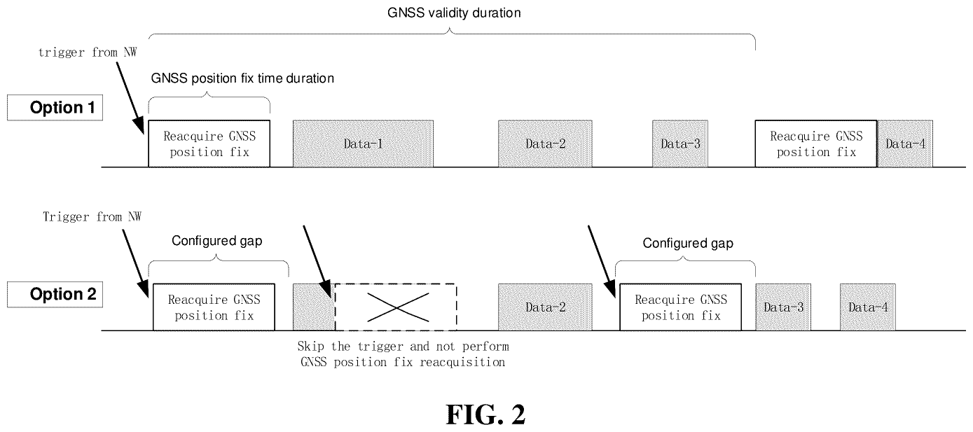

FIG. 2 highlights a brief comparison of Option 1 and Option 2. As depicted in FIG. 2, the top graph shows events occurring along horizontal (time) axis where a trigger is received from NW (left-most rectangle). The GNSS position fix time duration is shown by the width of the first rectangle, with additional occurrences of data transmission as time increases from left to right. At some time after the initial trigger, the UE may reacquire GNSS position fix. The time difference between two such reacquisitions may be equal to the GNSS validity duration.

As depicted in Option 2 graph at the bottom of FIG. 2, from left to right along the time axis, a trigger may be received from a network node based on a transmission performed by the network node. The “x” marks the above-described event where UE may skip the trigger and not perform GNSS position fix reacquisition because of an ongoing data transmission/reception.

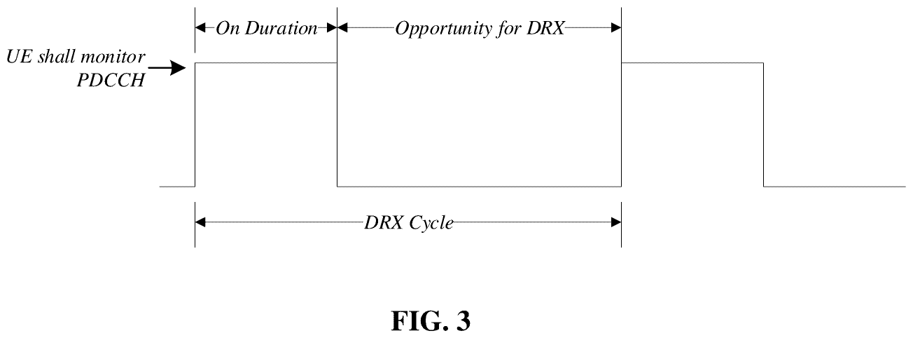

In order to reduce the interruption time caused by reacquisition of the GNSS position fix during the connected mode, there was some previous discussion about reacquiring GNSS position fix during the inactive state of Connected DRX. UE's connected mode DRX scheme (C-DRX) specifies the periodic repetition of the On Duration followed by a possible period of inactivity (see FIG. 3). Here the inactive state of Connected DRX corresponds to the opportunity for DRX in FIG. 3.

In previous discussion, there were some briefly analysis that, according to the current design of C-DRX timer, the maximum duration of DL/UL idle period is 32 PDCCH (physical downlink control channel) periods and the maximum PDCCH periods is 64 times of the duration required for the maximum repetition number. The corresponding DL/UL idle period can be as long as 1310 s. During the inactive state, UE is not required to transmit and receiving, including system information and paging. Therefore, it's feasible for UE (especially for the UE in GNSS hot start) to perform GNSS reacquisition autonomously during the inactive state of Connected DRX without interruption on the service data transmission. Also, the UE is able to finish the GNSS reacquisition before it ends up the inactive state and enters into next active state of Connected DRX.

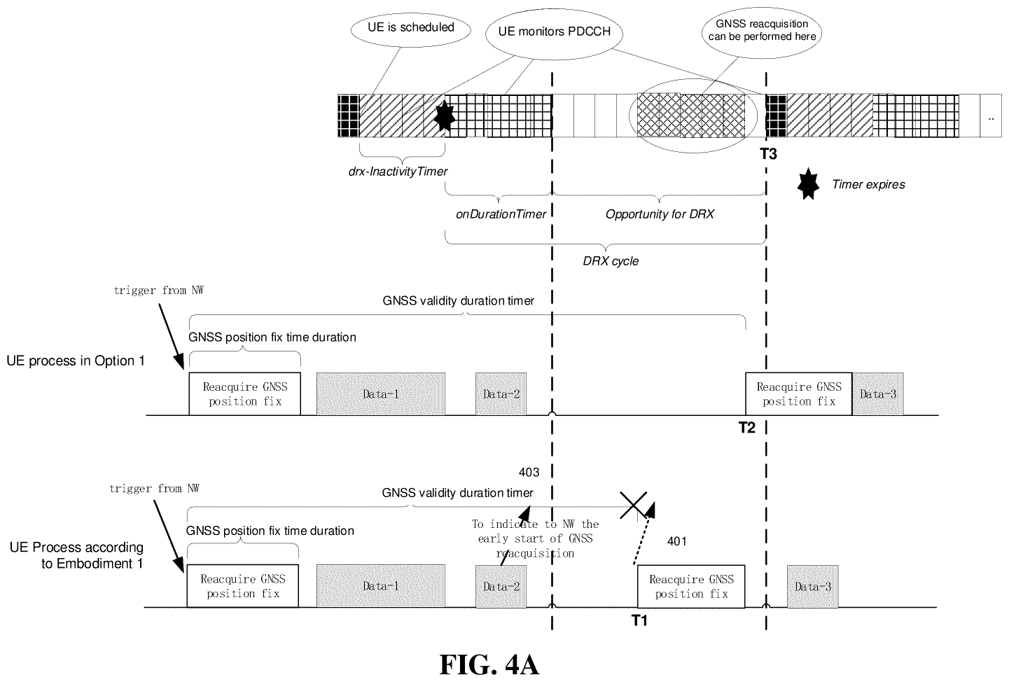

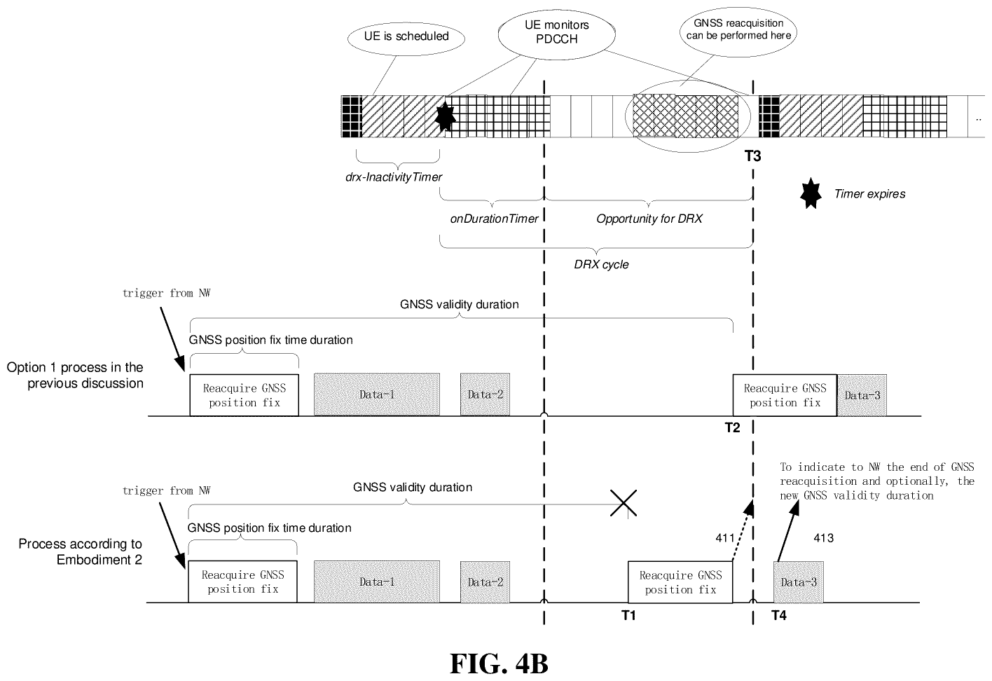

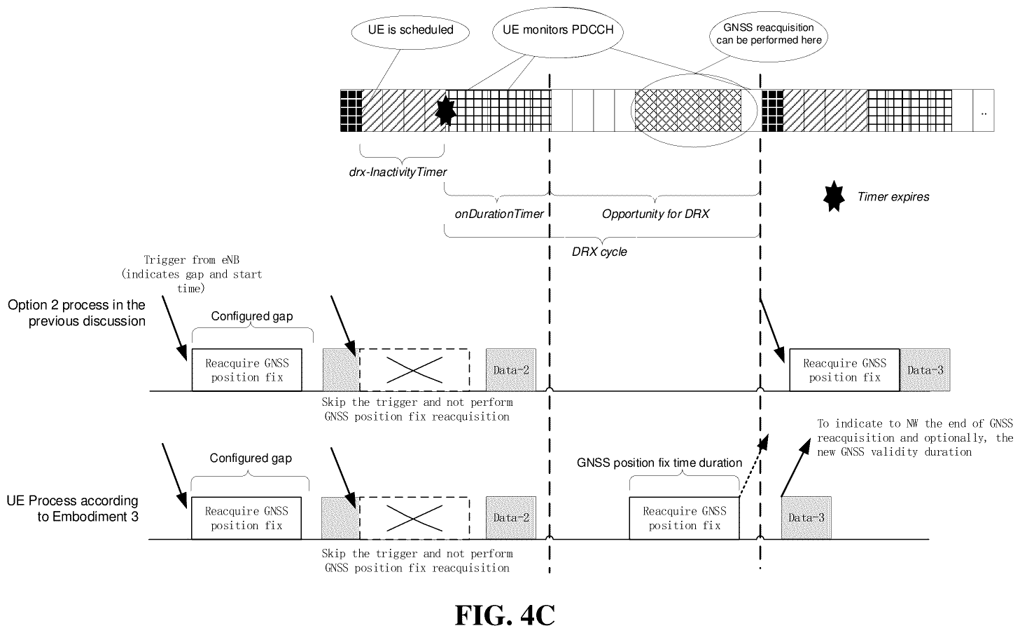

Various embodiments are now described with reference to FIGS. 4A-4C. In these figures, the horizontal axis represents time along which various events (e.g., transmission/reception of triggers, data etc.) are depicted. Various events such as UE being scheduled, UE monitoring PDCCH and GNSS reacquisition time window are depicted in the top portions of the drawings.

### 3. Embodiment 1 (Early Start of GNSS Reacquisition and UE Reports Start of GNSS Reacquisition)

In the Option 1, based on the knowledge of GNSS validity duration and GNSS position fix time duration reported by the UE, NW can have same understanding as UE of when the GNSS validity duration timer will expire (e.g., when the GNSS reacquisition will start) and also how long the GNSS reacquisition will take, therefore, it can stop the scheduling for the UE at the correct time period, e.g., during each time when UE performs GNSS reacquisition.

When UE is configured with C-DRX, an ideal case is that the expiration of GNSS validity duration timer is just within the inactive state of C-DRX and the time length of inactive state is also long enough for UE to complete the GNSS position fix reacquisition. In such case, there would be no service interruption. And there is no issue for NW as NW can also know this GNSS reacquisition and see it as a normal one. But it's easy to understand that since C-DRX is flexibly configured, this ideal situation would not always happen. More commonly, even if the expiration of GNSS validity duration timer can be within the inactive state of C-DRX, the GNSS reacquisition of UE may last until after end of inactive state (as depicted in FIG. 3), or, the expiration of GNSS validity duration timer occurs even after end of inactive state. In these cases, the service interruption is still unavoidable.

In this Embodiment 1, instead of UE starting to reacquire the GNSS position fix when the GNSS validity duration timer expires (e.g., at T2 time point), if UE determines that it's possible to complete GNSS reacquisition during inactive state of C-DRX, UE can deliberately stop the GNSS validity duration timer and start the GNSS position fix reacquisition early (e.g., at T1, which is earlier than T2) during inactive state of C-DRX. This is shown in FIG. 4A.

UE can decide when to start GNSS reacquisition as long as it is guaranteed to complete before end of inactive state of C-DRX. But in order that the reacquired GNSS can cover a period of time as long as possible, it's better for UE to start GNSS reacquisition as late as possible. One possible way to setting the T1 can be that with reference to the time point of end of inactive state, e.g., T3 and GNSS position fix time duration:

$$T 1 = T 3 - GNSS position fix time duration - {G}_{offset} \qquad ( 1 )$$

Wherein the G_{offset} can be configured by UE or NW, with value of zero or a positive value, and the smaller this value, the better.

However, if UE starts the GNSS position fix reacquisition early, e.g., earlier than the expiration of GNSS validity duration timer in order to align with the inactive state of C-DRX, the consistent understanding between UE and NW about the start of each time GNSS reacquisition would be broken. The NW cannot be aware of this occurrence and the NW will still begin to stop the scheduling for the UE at T1, which is completely unnecessary. In order to avoid such issue, UE needs to report kind of indication to inform NW about this early or temporarily GNSS reacquisition.

In this Embodiment 1, before the UE starts to perform GNSS position fix reacquisition, UE is required to report to the NW this early start of GNSS reacquisition. Moreover, UE can also report the expected exact start time point of GNSS reacquisition, e.g., T1, via RRC singling, MAC CE or L1 signaling etc. It is also possible for UE to use a specific or dedicated PRACH (physical random access channel) resource to indicate this early start of GNSS reacquisition to the NW. Based on UE's report, NW can also stop its GNSS validity duration timer accordingly and restart it after GNSS position fix reacquisition.

However, due to that during the inactive state of C-DRX, the NW would not schedule DL or UL for the UE, it will be kind of difficult for UE to report to NW just before its GNSS reacquisition. One possible alternative is that UE initiates a connected mode PRACH (physical random access channel) procedure and carry this report during the inactive state of C-DRX, see arrow 401 in FIG. 4A. If UE initiates a connected mode PRACH for this report, it can also include a new reason explicitly or implicitly to indicate the real purpose of this PRACH procedure. It's also possible for UE to use a specific or dedicated PRACH resource to indicate this early start of GNSS reacquisition to the NW.

Another possible alternative can be that, if UE can determine the T1 in advance, UE can inform the network about this expected early start of GNSS reacquisition and also the start time in future, e.g., T1, before the start of the inactive state of C-DRX. That means UE can send this report during the active state of C-DRX, for example, along with other service transmission, via RRC singling, MAC CE or L1 signaling etc. It's also possible for UE to use a specific or dedicated PRACH resource to indicate this early start of GNSS reacquisition to the NW. See arrow 402 in FIG. 4A. By this way, UE and NW can be aligned on the execution time of early GNSS reacquisition. Please note, here UE only reports the related information to NW, UE does not stop the GNSS validity duration timer and not start to reacquire GNSS.

Since what we are talking is an early GNSS reacquisition, it means that the current GNSS is still valid. Even if there is an opportunity to make use of the inactive state of C-DRX, if the validity period of current GNSS is still relatively long, there is no need to autonomously trigger GNSS acquisition too early. Therefore, in order to avoid unnecessary GNSS reacquisition, certain conditions can be set to control UE to trigger GNSS reacquisition only when appropriate. One possible condition is that, only when the remaining validity time period of the UE's current GNSS is less than a configured threshold, the UE can autonomously trigger GNSS reacquisition in the inactive state of C-DRX. This threshold can be configured by UE or NW.

### 4. Embodiment 2 (Early Start of GNSS Reacquisition and UE Reports End of GNSS Reacquisition)

Consider that it may be not easy for UE to report the early start of GNSS reacquisition and also the related start time in advance, e.g., before the start of performing GNSS reacquisition, especially when UE already enters the inactive state of C-DRX, in this Embodiment 2, another possible way is that UE can report the early start of GNSS reacquisition after the end of GNSS reacquisition.

UE can send this report as soon as the GNSS reacquisition is finished, in order to inform the NW as early as possible. As it's very possible that inactive state of C-DRX is not finished, e.g., the UE is still in the inactive state, UE also needs to initiate a connected mode PRACH procedure and carry this report, see the arrow 411 in FIG. 4B.

Since we can assume the interval between the end of GNSS reacquisition and the end of the inactive state, e.g., the G_{offset}, would be very short, UE also can pending this report and send it till the end of the inactive state. That means UE can send this report during the active state of C-DRX, e.g., at T4, for example, along with other service transmission, via RRC singling, MAC CE or L1 signaling etc., see the arrow 413 in FIG. 4A.

In FIG. 4B, as T4 is later than the T2 (subcase1), it would be the case that, when NW receives the report from the UE, the GNSS validity duration timer on the NW side have already expired and the NW has stopped DL/UL scheduling for the UE for a while. Even this is the case, it's still beneficial as the NW can restart the GNSS validity duration timer as soon as possible without waiting for the whole length of GNSS position fix time duration.

It's also possible that, when the NW receives the report, the GNSS validity duration timer on the NW side has NOT expired yet, e.g., T2 is later than T4 (subcase2). In this case, upon reception of the report, NW can immediately restart the GNSS validity duration timer and resume the scheduling for the UE.

No matter in subcase1 and subcase2, as the UE and NW restart the GNSS validity duration timer at different time points, the NW should apply a different time length for the GNSS validity duration timer in its own side, e.g., the remaining time of the GNSS validity duration timer in UE side.

In a summary, different from that in Embodiment 1, since the UE has finished the GNSS reacquisition when it sends the report, it may not be suitable to include the information that GNSS reacquisition is expected to start at some point, e.g., T1. Instead, UE can include one or more of the following contents in this report:
An indication to indicate that a GNSS reacquisition has been performed. The exact start time point of T1 can also be included;
The time point when the UE finishes the GNSS reacquisition, e.g., Tend;
Due to the mobility of the UE, it may be possible that UE determines the GNSS validity duration is changed at the end of GNSS reacquisition. Then the UE needs to report the new GNSS validity duration to the NW;

We assume the UE would restart the GNSS validity duration timer as soon as it finishes the GNSS reacquisition, e.g., at Tend. However, as mentioned above, the time points when UE sends the report and when the NW receives it would be later than Tend. In order to align the GNSS validity duration timer in both UE side and NW side again, the UE also needs to include the remaining time of current GNSS validity duration timer, or the time that has elapsed.

### 4. Embodiment 3 (Early Start of GNSS Reacquisition Without Waiting for Explicit Trigger From NW)

In Option 2, UE generally performs GNSS reacquisition only upon reception of the explicit trigger from radio network. In Embodiment 3, if Option 2 is applied, it can also be combined with the early start of GNSS reacquisition without explicit trigger from NW, as depicted in FIG. 4C.

Similar as mentioned in Embodiment 1 and Embodiment 2, if UE determines that the remaining time of the validity duration of current GNSS is less than a configured threshold (this threshold can be configured by UE or NW), even no explicit trigger is received by the UE, the UE can autonomously trigger GNSS reacquisition in the inactive state of C-DRX.

Moreover, in order to avoid that NW sends another explicit trigger during or shortly after UE's latest GNSS reacquisition, UE is also required to send a report to NW before it starts to perform GNSS reacquisition (e.g., via PRACH procedure) or after the GNSS reacquisition is completed and/or the inactive state of C-DRX is finished.

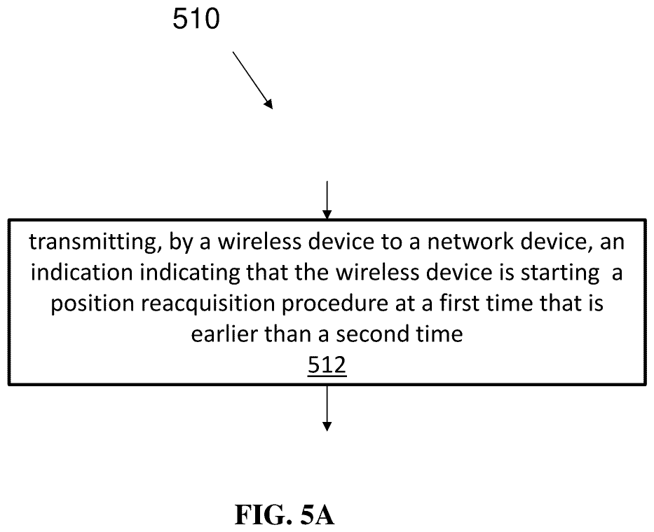

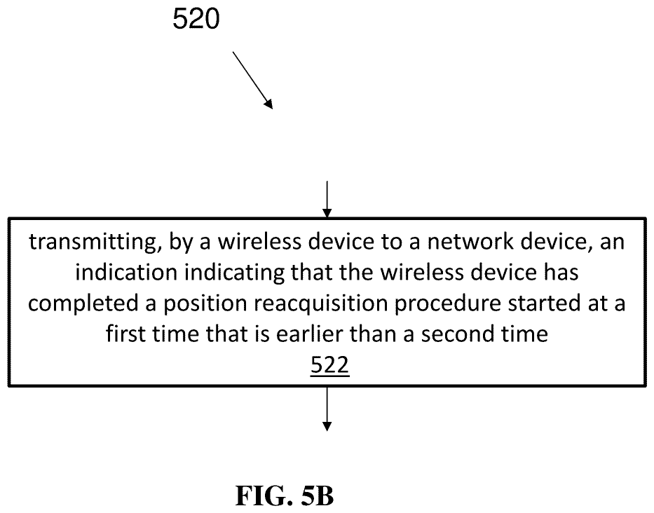

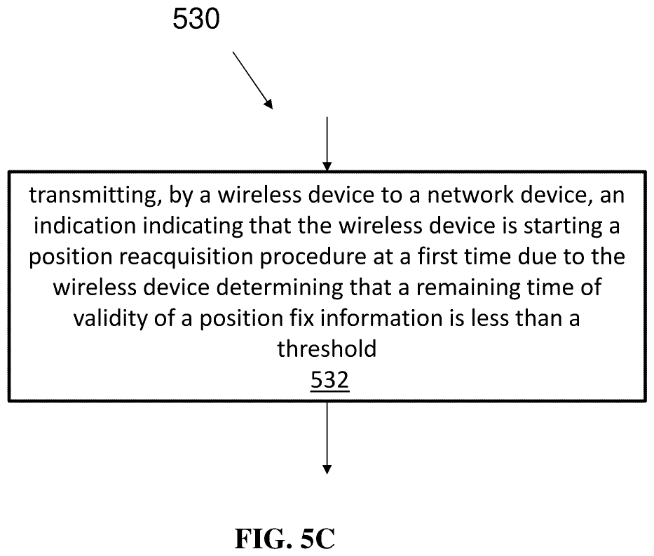

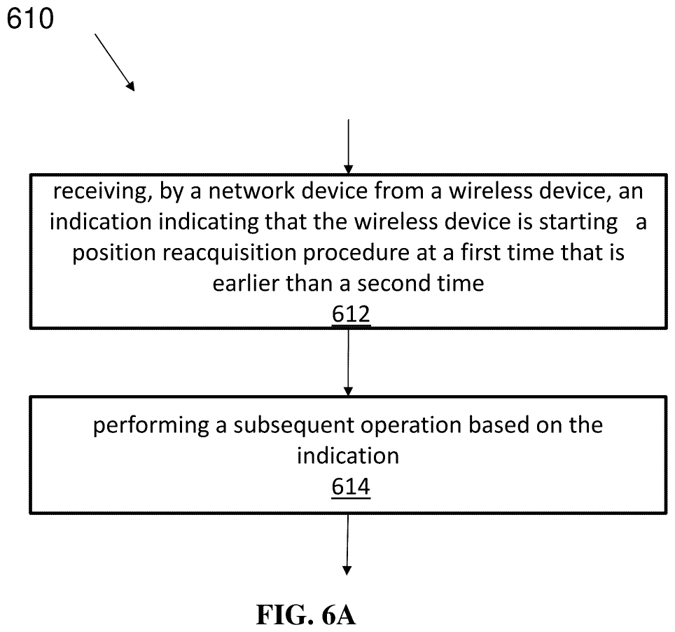

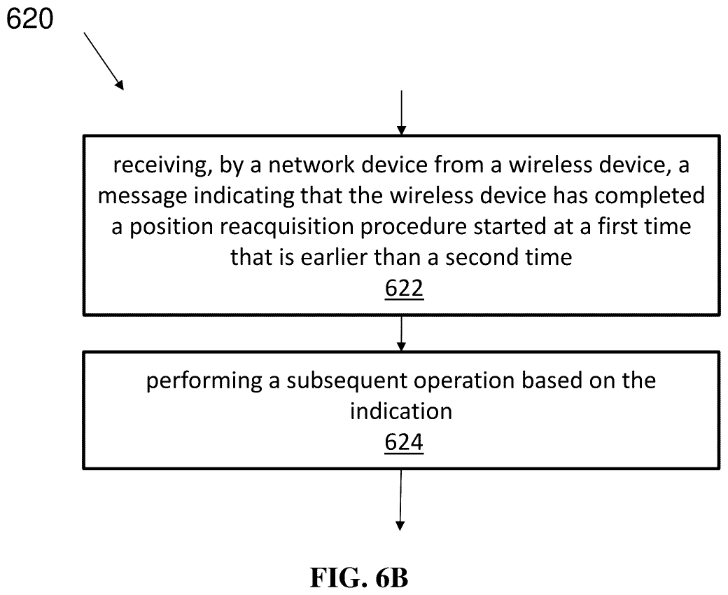

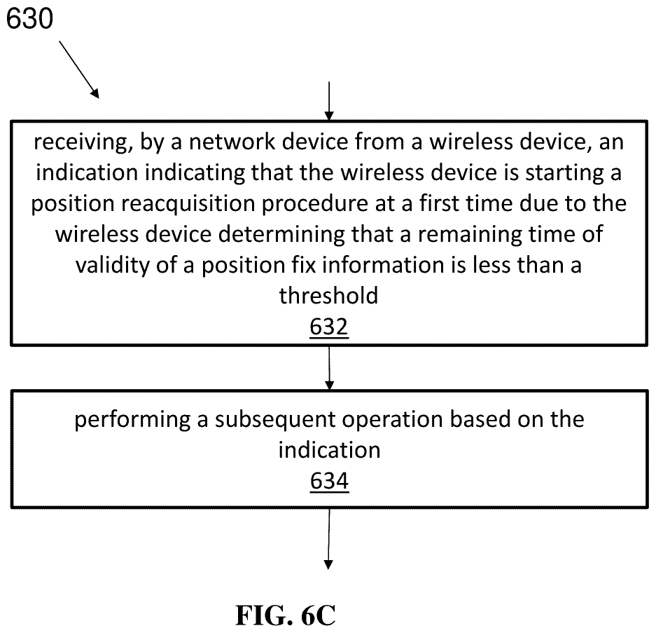

The following technical solutions may be preferably implemented by some preferred embodiments.
1. A method of wireless communication (e. g., method 510 depicted in FIG. 5A), comprising: transmitting (512), by a wireless device to a network device, an indication indicating that the wireless device is starting a position reacquisition procedure at a first time that is earlier than a second time according to a rule for starting the position reacquisition procedure.
2. A method of wireless communication (e.g., method 610 depicted in FIG. 6A), comprising: receiving (612), by a network device from a wireless device, an indication indicating that the wireless device is starting a position reacquisition procedure at a first time that is earlier than a second time according to a rule for starting the position reacquisition procedure; and performing (614) a subsequent operation based on the indication.
3. The method of any of solutions 1-2, wherein the first time corresponds to a time instant in a connected mode discontinuous reception mode operation (C-DRX).
4. The method of any of solutions 1-3, wherein: the first time is within an inactivity period of a discontinuous reception DRX cycle related to a DRX operation of the wireless device, or the first time is at a start of the inactivity period of the DRX cycle related to DRX operation of the wireless device.
5. The method of any of solutions 1-2, wherein the indication is transmitted (by the wireless device) or received (by the network device) while the wireless device is operating in a connected discontinuous reception mode (C-DRX).
6. The method of any of solutions 1-5, wherein the indication is transmitted (by the wireless device) or received (by the network device) using a physical random access channel (PRACH).
7. The method of any of solution 1-5, wherein the indication is transmitted (by the wireless device) or received (by the network device) as a medium access control message or a radio resource control message.
8. The method of any of solutions 5-7, wherein the indication is transmitted or received during an inactivity period or an active time of a DRX cycle related to a DRX operation of the wireless device.
9. The method of any of solutions 1-7, wherein the indication indicates the first time.
10. The method of any of solutions 1-9, wherein the indication is transmitted in case that the wireless device determines that a validity time period of a current position information is below a threshold.
11. The method of any of solutions 1-10, wherein the wireless device is operating in a non-terrestrial network.
12. The method of any of solutions 1-11, wherein the rule specifies that the second time corresponds to: a time of expiration of a global navigation satellite system (GNSS) validity duration timer or, a start time of a GNSS measurement configured by the network device.

In some embodiments, solutions 4 or 8 may comprises a DRX cycle that is a current DRX cycle or a next DRX cycle related to the DRX operation of the wireless device.

Additional features of the above solutions are described in Section 3 of the present document.
13. A method of wireless communication (e.g., method 520 depicted in FIG. 5B), comprising: transmitting (522), by a wireless device to a network device, an indication indicating that the wireless device has completed a position reacquisition procedure started at a first time that is earlier than a second time according to a rule for starting the position reacquisition procedure.
14. A method of wireless communication (e.g., method 620 depicted in FIG. 6B), comprising: receiving, by a network device from a wireless device, an indication indicating that the wireless device has completed a position reacquisition procedure started at a first time that is earlier than a second time according to a rule for starting the position reacquisition procedure; and performing (624) a subsequent operation based on the indication.
15. The method of any of solutions 13-14, wherein the first time corresponds to a time instant in a connected mode discontinuous reception mode operation (C-DRX).
16. The method of any of solutions 13-15, wherein: the first time is within an inactivity period of a discontinuous reception DRX cycle related to a DRX operation of the wireless device, or the first time is at a start of the inactivity period of the DRX cycle related to DRX operation of the wireless device.
17. The method of any of solutions 13-14, wherein the indication is transmitted (by the wireless device) or received (by the network device) while the wireless device is operating in a connected discontinuous reception mode (C-DRX).
18. The method of any of solutions 13-17, wherein the indication is transmitted (by the wireless device) or received (by the network device) using a physical random access channel (PRACH).
19. The method of any of solution 13-17, wherein the indication is transmitted (by the wireless device) or received (by the network device) as a medium access control message or a radio resource control message.
20. The method of any of solutions 17-19, wherein the indication is transmitted (by the wireless device) or received (by the network device) during an inactivity period or an active time of a DRX cycle related to a DRX operation of the wireless device.
21. The method of any of solutions 13-20, wherein the indication indicates an end time at which the position reacquisition procedure was completed.
22. The method of any of solutions 13-21, wherein the indication indicates a new validity duration for acquired position fix information.
23. The method of any of solutions 13-21, wherein the indication indicates a remaining time of a current position acquisition timer.

Additional features of the above solutions are described in Section 4 of the present document.
24. A method of wireless communication (e.g., method 530 depicted in FIG. 5C), comprising: transmitting (532), by a wireless device to a network device, an indication indicating that the wireless device is starting a position reacquisition procedure at a first time due to the wireless device determining that a remaining time of validity of a position fix information is less than a threshold.
25. A method of wireless communication (e.g., method 630 depicted in FIG. 6C), comprising: receiving (632), by a network device from a wireless device, an indication indicating that the wireless device is starting a position reacquisition procedure at a first time due to the wireless device determining that a remaining time of validity of a position fix information is less than a threshold; and performing (634) a subsequent operation based on the indication.
26. The method of any of solutions 24-25, wherein the threshold is determined by the wireless device.
27. The method of any of solutions 24-25, wherein the threshold is received from the network device.
28. The method of any of solutions 24-27, wherein the wireless device transmits the indication while the wireless device is within an inactivity period of a discontinuous reception DRX cycle related to a DRX operation of the wireless device.

Additional features of the above solutions are described in Section 5 of the present document.
29. A wireless communication apparatus comprising a processor configured to implement a method recited in any of the above recited-solutions.
30. A computer-readable medium having code stored thereon, the code, upon execution, causing a processor to implement a method recited in any of above solutions.

In the solutions, the subsequent operation performed by the network device may include, for example, a downlink communication with the wireless device according to the DRX operation, a setting of a timer, a control transmission or a data transmission, and so on.

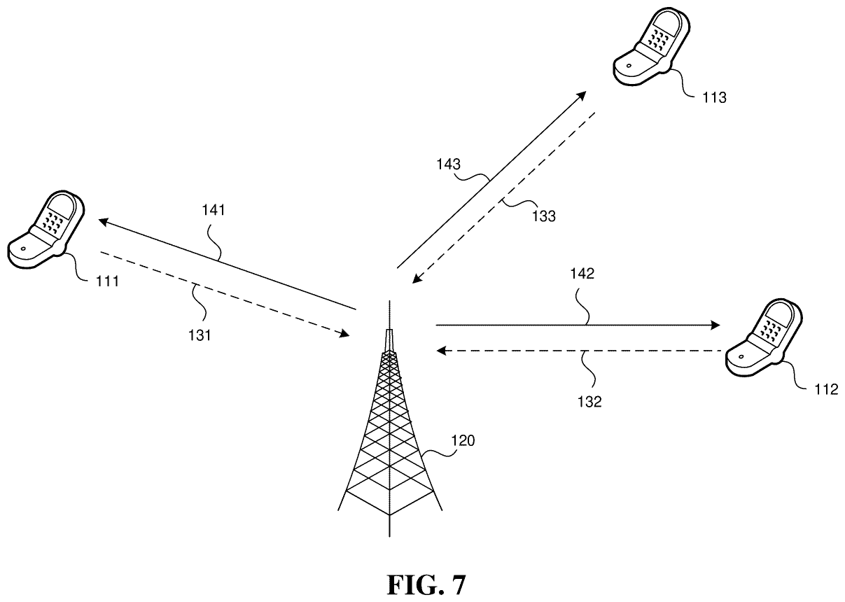

FIG. 7 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

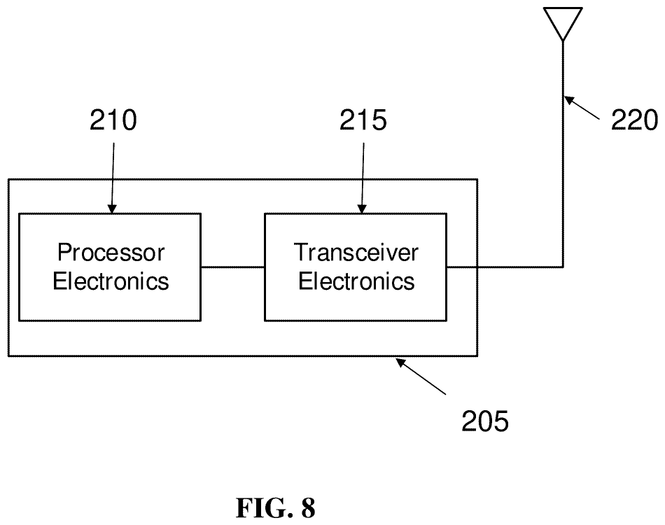

FIG. 8 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

It will be appreciated that the present document discloses various technique that may be implemented by embodiments of a network device (e.g., a base station) or a wireless device (e.g., a UE) such that position data reacquisition may be performed with C-DRX in a manner that is compatible with operation of the C-DRX and at the same time allows the UE to perform position information reacquisition in an expedient and efficient manner.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
transmitting, by a wireless device to a network device, an indication indicating that the wireless device has completed a position reacquisition procedure started at a first time that is earlier than a second time according to a rule for starting the position reacquisition procedure.

2. The method of claim 1, wherein the first time corresponds to a time instant in a connected mode discontinuous reception mode operation (C-DRX).

3. The method of claim 1, wherein:
the first time is within an inactivity period of a discontinuous reception DRX cycle related to a DRX operation of the wireless device.

4. The method of claim 1, wherein the indication is transmitted using a physical random access channel (PRACH).

5. The method of claim 1, wherein the indication is transmitted as a medium access control message.

6. The method of claim 1, wherein the indication indicates a remaining time of a global navigation satellite system (GNSS) validity duration.

7. A wireless device, comprising processor electronics configured to cause the wireless device to implement a method comprising:
transmitting, by a wireless device to a network device, an indication indicating that the wireless device has completed a position reacquisition procedure started at a first time that is earlier than a second time according to a rule for starting the position reacquisition procedure.

8. The wireless device of claim 7, wherein the first time corresponds to a time instant in a connected mode discontinuous reception mode operation (C-DRX).

9. The wireless device of claim 7, wherein the first time is within an inactivity period of a discontinuous reception DRX cycle related to a DRX operation of the wireless device.

10. The wireless device of claim 7, wherein the indication is transmitted using a physical random access channel (PRACH)

11. The wireless device of claim 7, wherein the indication is transmitted as a medium access control message.

12. The wireless device of claim 7, wherein the indication indicates a remaining time of a current position acquisition timer.

13. A method of wireless communication, comprising:
receiving, by a network device from a wireless device, an indication indicating that the wireless device has completed a position reacquisition procedure started at a first time that is earlier than a second time according to a rule for starting the position reacquisition procedure; and
performing a subsequent operation based on the indication.

14. The method of claim 13, wherein the first time corresponds to a time instant in a connected mode discontinuous reception mode operation (C-DRX).

15. The method of claim 13, wherein the first time is within an inactivity period of a discontinuous reception DRX cycle related to a DRX operation of the wireless device.

16. The method of claim 13, wherein the indication is received using a physical random access channel (PRACH)

17. The method of claim 13, wherein the indication is received as a medium access control message

18. The method of claim 15, wherein the indication indicates a remaining time of a current position acquisition timer.
